(19) United States
(12) Patent Application Publication
(10) Pub. No.: US 2025/0100846 A1
(43) Pub. Date: Mar. 27, 2025

(54) APPARATUS FOR PROVIDING ELEVATOR RIDE INFORMATION

(71) Applicant: Otis Elevator Company, Farmington, CT (US)

(72) Inventors: Xiaofei Guo, Shanghai (CN); Yunpeng Wang, Shanghai (CN)

(21) Appl. No.: 18/891,059

(22) Filed: Sep. 20, 2024

(30) Foreign Application Priority Data
Sep. 22, 2023 (CN) 202311231636.2

(51) Int. Cl. B66B 1/46; B66B 1/34; B66B 3/00

(52) U.S. Cl. CPC B66B 1/462; B66B 1/3492; B66B 3/004

(57) ABSTRACT

A device for providing elevator ride information includes a plurality of prompting modules. Each prompting module includes a sensor and a light-emitting unit, the sensor is configured to sense presence of an object to be transported above the prompting module. The prompting module further includes a control unit coupled with the plurality of prompting modules and configured to perform at least one of the following operations: i) in response to an event of car door opening, for the prompting module that does not sense the presence of the object to be transported, conditionally or unconditionally causing the light-emitting unit contained in the prompting module to enter a first operating state; ii) in response to an event of the car being about to arrive or having arrived at a destination floor, causing the light-emitting unit contained in all or some of the prompting modules to enter a second operating state.

### FOREIGN PRIORITY

This application claims priority to Chinese Patent Application No. 202311231636.2, filed Sep. 22, 2023, and all the benefits accruing therefrom under 35 U.S.C. § 119, the contents of which in its entirety are herein incorporated by reference.

### TECHNICAL FIELD OF INVENTION

The present application relates to elevator technology and, in particular, to a device for providing elevator ride information.

### BACKGROUND OF THE INVENTION

As a component of an elevator system, a car is used to transport passengers, goods, and other loads. A multi-car elevator system is often used in high-rise building to reduce waiting time and congestion by running multiple cars at the same time to divert people and goods. Other elevator systems are equipped with intelligent dispatch systems that use optimization algorithms to determine the task allocation of each car to minimize waiting time and congestion.

While the above technologies optimize the operational efficiency of the elevator system, they do not improve the ride experience inside the car.

### SUMMARY OF THE INVENTION

In accordance with an aspect of the present application, there is provided a device for providing elevator ride information, the device comprising a plurality of prompting modules provided above or integrated into an interior floor of a car. Each of the plurality if prompting modules comprises a sensor and a light-emitting unit, wherein the sensor is configured to sense presence of an object to be transported. The device further comprises a control unit coupled with the plurality of prompting modules and configured to perform at least one of the following operations: i) when the plurality of prompting modules comprising one or more first prompting modules that do not sense the presence of the object to be transported, in response to an event of car door opening, conditionally or unconditionally causing respective light-emitting units contained in the one or more first prompting modules to enter a first operating state; ii) in response to an event of the car being about to arrive or having arrived at a destination floor, causing light-emitting units contained in all or some of the plurality of prompting modules to enter a second operating state.

Optionally, in the above device, the plurality of prompting modules comprises a plurality of frames covering entire or partial area of a bottom of the car and having same or different shapes and occupying same or different areas.

Optionally, in the above device, the sensor is a pressure sensor that is disposed on a surface of the each of the plurality of prompting modules and generates a pressure signal corresponding to degree of deformation of the surface, and the light-emitting unit is disposed on the surface. Further optionally, the control unit is also configured to output a pressure value corresponding to the sensed pressure signal to an external device.

Optionally, in the above device, the sensor is a light sensor that is disposed on a surface of the each of the plurality of prompting modules and determines the presence of the object to be transported based on whether light is blocked or not, and the light-emitting unit is disposed on the surface.

Optionally, in the above device, the light-emitting unit in the each of the plurality of prompting modules comprises one or more light-emitting diodes.

Optionally, in the above device, the control unit is further configured to output an indicative signal regarding the presence of the object to be transported to an external device.

Optionally, in the above device, the control unit is configured to determine an occurrence of the event of car door opening and an occurrence of the event of the car being about to arrive or having arrived at the destination floor, based on a first trigger signal and a second trigger signal received from an external device, respectively.

Optionally, in the above device, the external device is an elevator control cabinet.

Optionally, in the above device, the first operating state is a constant light-emitting state, and the second operating state is a flashing light-emitting state.

Optionally, in the above device, the control unit is configured to cause the respective light-emitting units to enter the first operating state in the following manner: selecting one or more optimized prompting modules that meet an optimization objective from the one or more first prompting modules, wherein the optimization objective comprises at least making the object to be transported as evenly distributed as possible in the car; causing the respective light-emitting units contained in the one or more optimized prompting modules to enter the first operating state.

Optionally, in the above device, the control unit is configured to cause the light-emitting units contained in all or some of the plurality of prompting modules to enter the second operating state in the following manner: when the plurality of prompting modules comprising one or more second prompting modules that sense the presence of the object to be transported, if it is determined that the event of the car being about to arrive or having arrived at the destination floor occurs, causing the light-emitting units contained in the one or more second prompting modules to enter the second operating state.

In accordance with another aspect of the present application, there is provided a device for providing elevator ride information, the device comprising a plurality of prompting modules provided above or integrated into an interior floor of a car. Each of the plurality of prompting modules comprises a sensor, a light-emitting unit and a control unit. The sensor is configured to sense presence of an object to be transported. The control unit is coupled with the sensor and the light-emitting unit and performs at least one of the following operations: i) in response to an event of car door opening, causing the light-emitting unit to enter a first operating state when the sensor does not sense the presence of the object to be transported; ii) in response to an event of the car being about to arrive or having arrived at a destination floor, causing the light-emitting unit to enter a second operating state.

Optionally, in the above device, the external device is an elevator control cabinet or an elevator control panel.

### BRIEF DESCRIPTION OF THE DRAWINGS

The above and/or other aspects and advantages of the present application will be clearer and more easily understood from the following description of various aspects in conjunction with the accompanying drawings, in which the same or similar units are denoted by the same reference numerals. The accompanying drawings include:

FIG. 1 is a schematic block diagram of a device for providing elevator ride information in accordance with some embodiments of the present application.

FIG. 2 is an exemplary block diagram of one of prompting modules included in the device shown in FIG. 1.

FIG. 3 is an exemplary view of a frame in the prompting module shown in FIG. 1 or FIG. 2.

FIG. 4 is a schematic block diagram of a device for providing elevator ride information in accordance with some other embodiments of the present application.

FIG. 5 is an exemplary block diagram of one of prompting modules included in the device shown in FIG. 4.

FIG. 6 is a schematic block diagram of a control unit in the prompting module shown in FIG. 5.

### DETAILED DESCRIPTION OF THE INVENTION

The present application is described more fully below with reference to the accompanying drawings, in which illustrative embodiments of the application are illustrated. However, the present application may be implemented in different forms and should not be construed as limited to the embodiments presented herein. The presented embodiments are intended to make the disclosure herein comprehensive and complete, so as to more comprehensively convey the protection scope of the application to those skilled in the art.

In this specification, terms such as “comprising” and “including” mean that in addition to units and steps that are directly and clearly stated in the specification and claims, the technical solution of the application does not exclude the presence of other units and steps that are not directly and clearly stated in the specification and claims.

Unless otherwise specified, terms such as “first” and “second” do not indicate the order of the units in terms of time, space, size, etc., but are merely used to distinguish the units.

In this specification, terms “car floor”, “interior floor of a car”, or “floor of a car” refer to a bottom platform or floor inside an elevator car, which is used to support transported passengers, goods, and the like.

In this specification, term “elevator ride information” refers to various information that can reflect the ride status inside the car, including, for example, but not limited to, the distribution and number of objects to be transported (people or goods, etc.) inside the car, prompts about unoccupied/occupied areas inside the car, and prompts about the car approaching a specific location (e.g., a target floor, etc.), and the like.

In some embodiments of the present application, a prompting module for prompting the elevator ride information may include a sensor and a light-emitting unit. In addition, the prompting module may (but not necessarily) include a frame that houses the sensor and the light-emitting unit. Optionally, the prompting module is provided above the car floor, e.g. the prompting module may be located directly on a surface of the car floor, or stacked on the surface of the car floor through other components. Optionally, the prompting module may be integrated into the car floor in a manner that includes, for example, but is not limited to, the following: components of the prompting module (e.g., the frame) themselves constitute the car floor or the components of the car floor; components of the prompting module (e.g., the frame, the sensor, the light-emitting unit, etc.) are provided on the surface of the car floor or inside the car floor; and so on.

The sensor is configured to sense presence of an object to be transported above the frame. Optionally, the sensor may be realized as a pressure sensor that is disposed on the surface of the prompting module (e.g. on the surface of the frame) or on the surface of the car floor to sense the pressure applied on the prompting module or the car floor. By providing corresponding prompting modules in a plurality of areas of the car floor, it is possible to measure the pressure exerted on the various areas of the car floor, thus obtaining the distribution and number of objects to be transported inside the car.

Alternatively, the sensor may be realized as a light sensor (e.g. infrared sensor). The light sensor typically comprises an emitter and a receiver provided on the surface of the prompting module (e.g. on the surface of the frame) or the surface of the car floor, which may be used to detect the state of the light emitted by the emitter on the surface of the prompting module (blocked and unblocked). Similarly, when corresponding prompting modules are provided in a plurality of areas of the car floor, it is possible to obtain the state of the light in the plurality of areas of the car floor, thus obtaining the distribution and number of objects to be transported inside the car.

In addition, the light-emitting unit (e.g., comprising one or more light-emitting diodes and a switching element for controlling the on-off state of the current flowing through the light-emitting diodes) may indicate the elevator ride information with the aid of various operating states. For example, the light-emitting unit may be in a first operating state (e.g., a constant light-emitting state) when there is no object to be transported above the prompting module (at which time the pressure value sensed by the pressure sensor is less than a set threshold or the light emitted by the emitter is not blocked); the light-emitting unit may be caused to enter a second operating state (e.g., a flashing light-emitting state) when the car is about to arrive at a destination floor in order to inform passengers of the arrival of the destination floor; when there is an object to be transported above the prompting module (at which time the pressure value sensed by the pressure sensor is greater than or equal to the set threshold or the light emitted by the emitter is blocked), the light-emitting unit may be in a third operating state (e.g., extinguished state).

It is to be noted that the above operating state of the light-emitting unit and the mapping relationship between the above operating state and the elevator ride information to be represented are merely exemplary rather than restrictive, and various modifications, such as adding, deleting, or changing, may be made to the above operating state and the mapping relationship based on specific application requirements.

In some embodiments, the control unit for controlling the operating state of the light-emitting unit and generating the elevator ride information using the presence of the object to be transported sensed by the sensor is provided outside the prompting module (e.g., an elevator operation panel or an elevator control cabinet, etc., may be utilized to implement the function of the control unit). In other embodiments, the control unit described above is provided within the prompting module (e.g., located within the frame described above) as a hardware entity independent of other control components within the elevator system.

It should be emphasized that sensing the presence of the object to be transported and presenting the elevator ride information are two unrelated functions or requirements. Furthermore, both sensing the presence and presenting the elevator ride information may be realized in various ways (e.g., by installing a light sensor at the car door to sense passengers entering and exiting the car door, and by presenting the information on the walls or the top of the car). In the embodiments described in the present application, the above functions are implemented together by providing the sensor at the bottom of the car and presenting the elevator ride information “from bottom to top”, i.e., the hardware for implementing the above functions is integrated into a physical entity (prompting module), and the physical entity itself may also form some of the structure of the car.

It should also be emphasized that the “from bottom to top” presentation of the elevator ride information can significantly improve the user experience. In particular, the ubiquitous use of mobile phones in modern society has created a large number of “heads down” users. The “from bottom to top” presentation conforms to the trend and habit of people using electronic products, achieving effective and efficient delivery of the elevator ride information to the passengers.

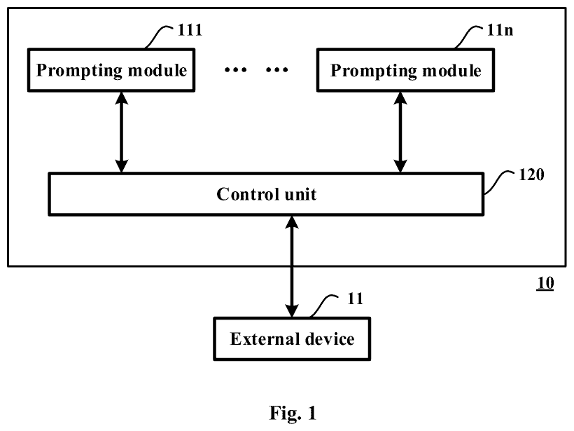

FIG. 1 is a schematic block diagram of a device for providing elevator ride information in accordance with some embodiments of the present application. Referring to FIG. 1, a device 10 for providing elevator ride information comprises a plurality of prompting modules 111 to 11n and a control unit 120. Each prompting module may comprise, in addition to a sensor and a light-emitting unit, a frame (not shown) housing the sensor and the light-emitting unit, which may be an integral some of a car floor or may be provided as a component independent of the car floor and above or within the car floor. It should be noted that, in either case, there is no special limit on the location of the prompting module, as long as it is possible to enable the sensor to sense the presence of the object to be transported and to enable the light emitted by the light-emitting unit to be observed in the area outside of the car floor.

The frame defines the boundaries of the prompting modules, whereby the prompting modules 111 to 11n may be made to cover entire area of a bottom of the car or a designated portion of the area with the aid of the frame. It is noted that the frame may be of various shapes including, but not limited to, rectangles, squares, hexagons, circles, ovals, and the like. The frames of the individual prompting modules may have the same or different shapes and may occupy the same or different areas.

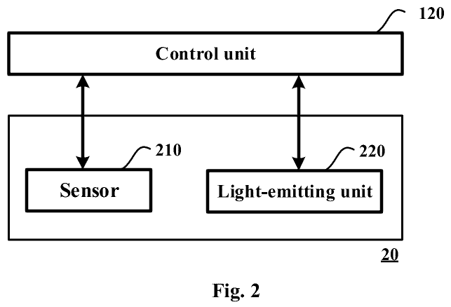

FIG. 2 is an exemplary block diagram of one of prompting modules included in the device shown in FIG. 1. As shown in FIG. 2, a prompting module 20 includes a frame (not shown), a sensor 210, and a light-emitting unit 220. As described above, the frame may be an integral some of the car floor, or may be provided above or within (on the surface of, or within) the car floor. The sensor 210 may be provided on the surface or inside of the frame, which may be, for example, a pressure sensor or a light sensor. The sensor 210 is configured to sense the presence of the object to be transported above the frame (e.g. based on a pressure value or a light state), and the sensed signals (e.g. a pressure signal or a light state signal) may be used by the control unit 120 to generate the elevator ride information. The light-emitting unit 220 may be provided on the surface or inside of the frame, and it is in various operating states under the control of the control unit 120, as will be further described below.

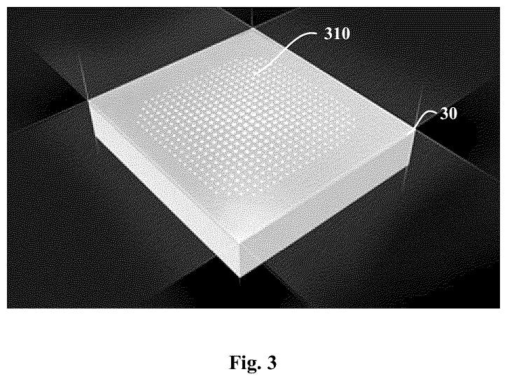

FIG. 3 is an exemplary view of a frame in the prompting module shown in FIG. 1 or FIG. 2. As shown in FIG. 3, a frame 30 has a shape similar to a floor tile, which may be laid on the surface of the car floor. A plurality of light transmissive holes 310 are provided on the surface of the frame 30, and light emitted from the light-emitting unit (which is provided, for example, on the lower surface of the frame) may exit through the light transmissive holes 310. Further, when the sensor is a pressure sensor, it may be provided on the upper or lower surface of the frame 30 to sense a pressure applied to the surface of the frame. When the sensor is a light sensor, an emitter and a receiver comprised therein may be provided on the upper surface of the frame 30 to sense a state (blocked or unblocked) of the light emitted by the emitter.

It should be noted that the frame in the prompting module 20 is an omissible component, and when the frame is omitted, the sensor 210 and the light-emitting unit 220 may be provided above or within the car floor (on the surface of the car floor or inside the car floor), and the car floor may also have one or more features possessed by the frame (e.g., a shape, a light transmissive hole, a surface capable of generating sufficient deformation, etc.).

The control unit 120 may communicate with each of the prompting modules 111 to 11n via a communication cable or a wireless channel to obtain the sensed value of the sensor and to realize control of the operating state of the light-emitting unit, for example, by controlling a switching element in the light-emitting unit. In the embodiment shown in FIG. 1, the control unit 120 is provided external to the prompting modules. In some embodiments, the functions of the control unit 120 may be implemented with the aid of a control component that is already present within the elevator system, such as an elevator control cabinet or an elevator operation panel in the car.

In some embodiments, in order to present the current ride status of the car (e.g., the number of passengers, the load capacity and the ratio of the number of passengers to the number of passengers permitted, etc.) to the passengers waiting for an elevator, the control unit 120 may obtain the measurements (e.g., pressure signal or light intensity signal, etc.) sensed by the corresponding sensor by communicating with each of the prompting modules and determine the current number of passengers in the car (e.g., the number of prompting modules with a pressure value greater than or equal to a set threshold is presumed to be the number of passengers, or the presence of an object to be transported above the prompting module to which it belongs is presumed to be based on the blocked light, etc.), the ratio of the number of passengers to the number of passengers permitted, or the load capacity, based on the obtained measurements. Optionally, the control unit 120 transmits information about the current ride status by means of wired communication or wireless communication to a display screen or a voice device located in a hall door area, which, in turn, presents the information.

In other embodiments, the control unit 120 presents the location guidance information by controlling the operating state of the light-emitting unit. Optionally, in response to an event of the car door opening, the control unit 120 may cause the light-emitting unit within the prompting module that does not sense the object to be transported to be in a set operating state (e.g., a constant light-emitting state or a flashing light-emitting state) in order to prompt passengers entering the car to arrive at the location where the prompting module that does not sense the object to be transported is located. Further optionally, when there is a plurality of prompting modules or locations where the object to be transported is not sensed, the control unit 120 may determine one or more recommended occupied locations based on a set optimization objective (e.g., to make the object to be transported as evenly distributed as possible, etc.) and cause the light-emitting unit(s) within the prompting module(s) that do not sense the object to be transported located at the location(s) to be in a set operating state (e.g., a constant light-emitting state or a flashing light-emitting state).

In some specific implementations, the control unit 120 (e.g., the elevator operation panel) may determine whether the event of the car door opening has occurred based on a signal S1 received from an external device 11 (e.g., the elevator control cabinet) regarding the car door opening. For example, if the signal S1 is received from the external device, it is determined that the event of the car door opening has occurred.

In some other embodiments, the control unit 120 presents a prompt message that the car has arrived at the destination floor by controlling the state of the light-emitting unit. Specifically, in response to an event of the car being about to arrive (e.g., a few seconds before opening the car door) or having arrived at the destination floor, the control unit 120 causes the light-emitting unit within the prompting module to be in a set operating state (e.g., a flashing light-emitting state). Optionally, the control unit 120 may cause the light-emitting unit contained in all of the prompting modules to be in the set operating state. Alternatively, the control unit 120 may cause the light-emitting unit contained in only a portion of the prompting modules (e.g., those prompting modules carrying the objects to be transported) to be in the set operating state.

In some specific embodiments, the control unit 120 (e.g., the elevator operation panel) may determine whether the event has occurred based on a signal S2 received from an external device (e.g., the elevator control cabinet) regarding the car being about to arrive or having arrived at the destination floor. For example, if the signal S2 is received from the external device, it is determined that the event of the car being about to arrive or having arrived at the destination floor has occurred.

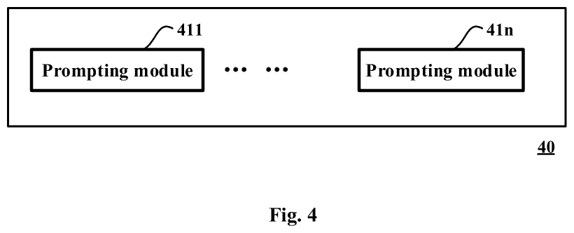

FIG. 4 is a schematic block diagram of a device for providing elevator ride information in accordance with some other embodiments of the present application. Referring to FIG. 4, a device 40 for providing elevator ride information comprises a plurality of prompting modules 411 to 41n. Each prompting module also comprises a frame, but unlike the embodiment shown in FIG. 1, the prompting module comprises a control unit in addition to a sensor and a light-emitting unit.

The prompting modules 411 to 41n shown in FIG. 4 may comprise a frame, which may have the various structures and features described above and modifications and improvements thereof. For example, it may be an integral some of the car floor or may be provided as a component independent of the car floor and above or within the car floor. As another example, the frames of the prompting modules 411 to 41n may cover entire area of a bottom of the car or a designated portion of the area, and may be of various shapes, may have the same or different shapes, and may occupy the same or different areas. Also for example, in the embodiment shown in FIG. 4, the frame may also be of the style shown in FIG. 3.

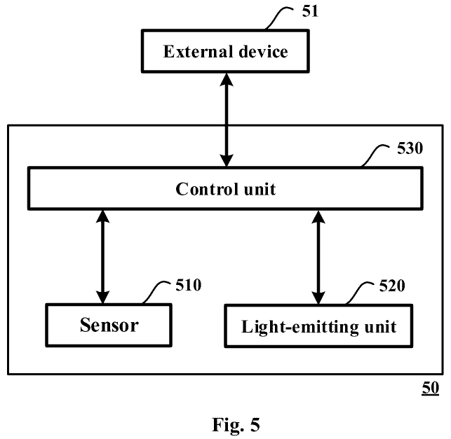

FIG. 5 is an exemplary block diagram of one of prompting modules included in the device shown in FIG. 4. As shown in FIG. 5, a prompting module 50 includes a frame (not shown), a sensor 510, a light-emitting unit 520, and a control unit 530. Similarly, the sensor 510 (e.g., a pressure sensor or a light sensor) may be disposed on a surface or inside of the frame to sense the presence of the object to be transported above the frame. The light-emitting unit 520 may be provided on the surface or inside of the frame, and it is in various operating states under the control of the control unit 530 (e.g., by controlling a switching element in the light-emitting unit), as will be further described below.

It is also to be noted that the prompting modules 411 to 41n and the frame in 50 are also omissible components, i.e., the sensor 510 and the light-emitting unit 520 may be provided directly above or within the car floor (on the surface of the car floor or inside the car floor), and the car floor may also have one or more features similar to those of the frame.

The control unit 530 is coupled with the sensor 510 to obtain the sensed value of the sensor 510. In addition, the control unit 530 is coupled with the light-emitting unit 520 to control the operating state of the light-emitting unit 520 based on the sensed value, so as to present the corresponding elevator ride information to the passenger with the help of the light-emitting unit 520. In the embodiment shown in FIG. 5, the control unit 530 is provided inside (e.g., inside the frame) the prompting module 50. That is, the control unit 530 is a hardware entity that is independent of the control components already present within the elevator system.

In some embodiments, the control unit 530 may acquire the sensed measurements (e.g., pressure and light intensity, etc.) by communicating with the sensor 510 and determine whether the object to be transported is present at the location of the prompting module 50 (e.g., if the pressure value is greater than or equal to a set threshold value, it is judged that the object to be transported is present, or if the light intensity is less than a set threshold value, it is judged that the object to be transported is present) based on the acquired measurements. Optionally, the control unit 530 may transmit the acquired measurements or judgment results based on the measurements to an external device (e.g., an elevator control cabinet, an elevator operation panel) by means of wired or wireless communication, and the external device generates the current ride status of the car (e.g., the number of passengers, the load capacity and the ratio of the number of passengers to the number of passengers permitted, etc.) based on the measurements or judgment results based on the measurements transmitted by the control unit 530 for presenting by a display screen or a voice device located in a hall door area.

In other embodiments, the control unit 530 presents the location guidance information by controlling the state of the light-emitting unit 520. Optionally, the control unit 530 may determine whether the event of the car door opening has occurred based on a signal S1 received from an external device 51 (e.g., an elevator control cabinet or an elevator operation panel) regarding the car door opening. When determining that the event has occurred, if the control unit 530 determines that there is no object to be transported at the location of the prompting module 50 based on the measurements of the sensor 510, the light-emitting unit 520 is caused to be in a set operating state (e.g., a constant light-emitting state or a flashing light-emitting state) to prompt a passenger entering the car to arrive at the location where the prompting module is located.

In still other embodiments, the control unit 530 presents a prompt message that the car has arrived at the destination floor by controlling the state of the light-emitting unit. Optionally, the control unit 530 may determine whether the event of the car being about to arrive or having arrived at the destination floor has occurred based on a signal S2 received from an external device (e.g., an elevator control cabinet or an elevator operation panel) regarding the car being about to arrive or having arrived at the destination floor. When determining that the event has occurred, the control unit 530 causes the light-emitting unit 520 to be in a set operating state (e.g., a flashing light-emitting state) regardless of whether or not the object to be transported is present at the location of the prompting module 50. Alternatively, when it is determined that the event of the car being about to arrive or having arrived at the destination floor has occurred, the control unit 530 causes the light-emitting unit 520 to be in the set operating state only if there is the object to be transported is present at the location of the prompting module 50.

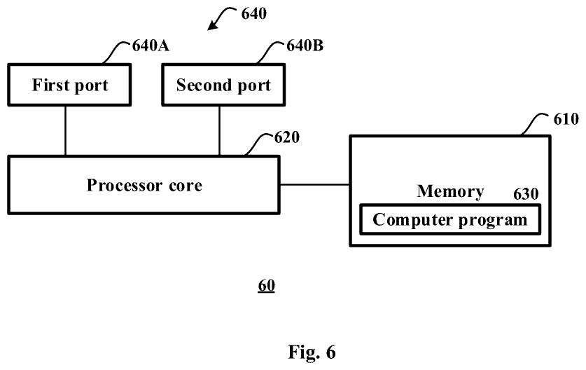

FIG. 6 is a schematic block diagram of a control unit in the prompting module shown in FIG. 5. As shown in FIG. 6, a control unit 60 comprises memory 610 (e.g., a non-volatile memory such as a flash memory, a ROM, a hard disk drive, a magnetic disk, an optical disc, etc.), a processor core 620, computer program 630 that is stored in the memory 610 and may be run on the processor core 620, a port group 640, and a communication interface 650.

Continuing to refer to FIG. 6, the port group 640 comprises a first port 640A and a second port 640B. The first port 640A is coupled with the sensor 510 to obtain the measurements, and the second port 640B is coupled with the light-emitting unit 520 to control the operating state of the light-emitting unit.

By running the computer program 630, the processor core 620 may control the operating state of the light-emitting unit 520 based on the measurements sensed by the sensor 510. The specific control logic is described above in connection with FIGS. 4 and 5 and will not be repeated herein.

It is noted that the various illustrative logical blocks, modules, circuits, and algorithm steps described herein may be implemented as electronic hardware, computer software, or combinations of both.

To demonstrate this interchangeability between the hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present application.

Although only a few of the specific embodiments of the present application have been described, those skilled in the art will recognize that the present application may be embodied in many other forms without departing from the spirit and scope thereof. Accordingly, the examples and implementations shown are to be regarded as illustrative and not restrictive, and various modifications and substitutions may be covered by the application without departing from the spirit and scope of the application as defined by the appended claims.

The embodiments and examples presented herein are provided to best illustrate embodiments in accordance with the present technology and its particular application, and to thereby enable those skilled in the art to implement and use the present application. However, those skilled in the art will appreciate that the above description and examples are provided for convenience of illustration and example only. The presented description is not intended to cover every aspect of the application or to limit the application to the precise form disclosed.

What is claimed is:

1. A device for providing elevator ride information, comprising:
a plurality of prompting modules provided above or integrated into an interior floor of a car, each comprising a light-emitting unit and a sensor being configured to sense presence of an object to be transported; and
a control unit coupled with the plurality of prompting modules and configured to perform at least one of the following operations:
i) when the plurality of prompting modules comprising one or more first prompting modules that do not sense the presence of the object to be transported, in response to an event of car door opening, conditionally or unconditionally causing respective light-emitting units contained in the one or more first prompting modules to enter a first operating state;
ii) in response to an event of the car being about to arrive or having arrived at a destination floor, causing light-emitting units contained in all or some of the plurality of prompting modules to enter a second operating state.

2. The device of claim 1, wherein the plurality of prompting modules further comprise a plurality of frames covering entire or partial area of a bottom of the car and having same or different shapes and occupying same or different areas.

3. The device of claim 1, wherein the sensor in the each of the plurality of prompting modules is a pressure sensor that is disposed on a surface of the each of the plurality of prompting modules and generates a pressure signal corresponding to degree of deformation of the surface, and the light-emitting unit in the each of the plurality of prompting modules is disposed on the surface.

4. The device of claim 1, wherein the sensor in the each of the plurality of prompting modules is a light sensor that is disposed on a surface of in the each of the plurality of prompting modules and determines the presence of the object to be transported based on whether light is blocked or not, and the light-emitting unit in the each of the plurality of prompting modules is disposed on the surface.

5. The device of claim 1, wherein the light-emitting unit in the each of the plurality of prompting modules comprises one or more light-emitting diodes.

6. The device of claim 1, wherein the control unit is further configured to output an indicative signal regarding the presence of the object to be transported to an external device.

7. The device of claim 3, wherein the control unit is further configured to output a pressure value corresponding to the sensed pressure signal to an external device.

8. The device of claim 1, wherein the control unit is configured to determine an occurrence of the event of car door opening and an occurrence of the event of the car being about to arrive or having arrived at the destination floor, based on a first trigger signal and a second trigger signal received from an external device, respectively.

9. The device of claim 6, wherein the external device is an elevator control cabinet.

10. The device of claim 1, wherein the first operating state is a constant light-emitting state, and the second operating state is a flashing light-emitting state.

11. The device of claim 1, wherein the control unit is configured to cause the respective light-emitting units to enter the first operating state in the following manner:
selecting one or more optimized prompting modules that meet an optimization objective from the one or more first prompting modules, wherein the optimization objective comprises at least making the object to be transported as evenly distributed as possible in the car;
causing the respective light-emitting units contained in the one or more optimized prompting modules to enter the first operating state.

12. The device of claim 1, wherein the control unit is configured to cause the light-emitting units contained in all or some of the plurality of prompting modules to enter the second operating state in the following manner:
when the plurality of prompting modules comprising one or more second prompting modules that sense the presence of the object to be transported, if it is determined that the event of the car being about to arrive or having arrived at the destination floor occurs, causing the light-emitting units contained in the one or more second prompting modules to enter the second operating state.

13. A device for providing elevator ride information, comprising a plurality of prompting modules provided above or integrated into an interior floor of a car, each comprising a light-emitting unit, a sensor being configured to sense presence of an object to be transported, and a control unit,
wherein the control unit is coupled with the sensor and the light-emitting unit and performs at least one of the following operations:
i) in response to an event of car door opening, causing the light-emitting unit to enter a first operating state when the sensor does not sense the presence of the object to be transported;
ii) in response to an event of the car being about to arrive or having arrived at a destination floor, causing the light-emitting unit to enter a second operating state.

14. The device of claim 13, wherein each of the plurality of prompting modules further comprises a frame, the frame covering entire or partial area of a bottom of the car and having same or different shapes and occupying same or different areas as compared to other of the plurality of prompting modules.

15. The device of claim 13, wherein the sensor is a pressure sensor that is disposed on a surface of the each of the plurality of prompting modules and generates a pressure signal corresponding to degree of deformation of the surface, and the light-emitting unit is disposed on the surface.

16. The device of claim 13, wherein the sensor is a light sensor that is disposed on a surface of the each of the plurality of prompting modules and determines the presence of the object to be transported based on whether light is blocked or not, and the light-emitting unit is disposed on the surface.

17. The device of claim 13, wherein the light-emitting unit comprises one or more light-emitting diodes.

18. The device of claim 13, wherein the control unit is further configured to output an indicative signal regarding the presence of the object to be transported to an external device.

19. The device of claim 15, wherein the control unit is further configured to output a pressure value corresponding to the sensed pressure signal to an external device.

20. The device of claim 13, wherein the control unit is configured to determine an occurrence of the event of car door opening and an occurrence of the event of the car being about to arrive or having arrived at the destination floor, based on a first trigger signal and a second trigger signal received from an external device, respectively.

21. The device of claim 18, wherein the external device is an elevator control cabinet or an elevator control panel.

22. The device of claim 13, wherein the first operating state is a constant light-emitting state, and the second operating state is a flashing light-emitting state.

23. The device of claim 13, wherein the control unit is configured to cause the light-emitting unit to enter the second operating state in the following manner:
if it is determined that the event of the car being about to arrive or having arrived at the destination floor occurs and the sensor senses the presence of the object to be transported, causing the light-emitting unit to enter the second operating state.
